(19) United States
(12) Patent Application Publication
(10) Pub. No.: US 2011/0015921 A1
(43) Pub. Date: Jan. 20, 2011

(54) SYSTEM AND METHOD FOR USING LINGUAL HIERARCHY, CONNOTATION AND WEIGHT OF AUTHORITY

(75) Inventor: Stan Kuruvilla, Wynnewood, PA (US)

Correspondence Address: VOLPE AND KOENIG, P.C., UNITED PLAZA, 30 SOUTH 17TH STREET, PHILADELPHIA, PA, 19103, US

(73) Assignee: MINERVA ADVISORY SERVICES, LLC, Wynnewood, PA (US)

(21) Appl. No.: 12/839,172

(22) Filed: Jul. 19, 2010

Related U.S. Application Data
(60) Provisional application No. 61/226,525, filed on Jul. 17, 2009.

(51) Int. Cl. G06F 17/27

(52) U.S. Cl. 704/9

(57) ABSTRACT

An authoring environment comprising a linguistic construction tool and method to allow qualitative search and representation of results that may use one or any combination of lingual hierarchy, connotation and weight of authority for constructing a multidimensional conceptual model applicable to one or more documents. The linguistic construction tool and method may be used to augment the authoring process and the resulting documents. The linguistic construction tool may also be used to perform search related activities.

### CROSS REFERENCE TO RELATED APPLICATIONS

This application claims the benefit of U.S. Provisional Application No. 61/226,525 filed on Jul. 17, 2009, which is hereby incorporated by reference.

### TECHNOLOGY FIELD

This application is related to educational tools, word processing systems, browsers and search engine technologies.

### BACKGROUND

The authoring process is a complex one. The word processor and the web browser have produced significant changes in the way authors pursue their craft. Consider for instance, that the advent of word processing systems on personal computers may help reduce the tedium and effort involved with writing by hand or using a typewriter. Meanwhile, web browsers and the availability of content on the internet have also materially changed how authors conduct and collect research for their writing efforts.

Word processors may provide a variety of typesetting and professional presentation features. However, they may not provide much to support the creative aspect of the writing process, thought construction, and argument construction. Some word processors may provide spell checkers, thesaurus functionality or a research panel for connecting to external content, however these tools may not provide the author adequate support. Browsers may provide a variety of technologies to support collection of information from the simple cut-and-paste operation to inline note-taking capabilities. However, even the most sophisticated browsers may fall short in aiding the author in supporting the language and thought construction aspect of the authoring process.

Part of the authoring process may involve filling in gaps in knowledge through research, fact checking to establish grounds for a statement, and linking material across multiple sources. The writing process may also include drafting and refining ideas expressed as sentences and paragraphs of material in a document. Most authors perform these tasks, and others, implicitly while working across disconnected islands of activity in word processors and web browsers. The author may perform these tasks implicitly because word processors may not provide the information necessary to fill in conceptual and factual gaps in the documents being written using them, and the browsers may not provide the writing capabilities of word processors.

Moreover, since an author may select material and express it as a query into a browser, there may be data loss with respect to the results that are returned and the degree of relevance to the subject that is being written about. Finally, the sheer volume of material on the internet ensures that even a sophisticated query may return a significant number of results that will then have to be refined before the author may return to the place where they were in the creative process when the need for more information arose.

It would therefore be desirable to have a method and apparatus that provides active, assisted creative support to allow an author to continuously engage in the creative process without having the boundaries of a word processor and a web browser limit and distract from the endeavor. A process by which an author informs themselves, contemplates any new material, and expresses themselves using the new material may be referred to as the inform-contemplate-express cycle. It would therefore be desirable to have a method and apparatus that would relieve authors from implicitly orchestrating this activity and explicitly using the web browser and the word processor and allow authors to engage in expression as they iterate through each cycle of their work. Using a method and apparatus to shorten this inform-contemplate-express cycle would be desirable.

### SUMMARY

An authoring environment comprising a linguistic construction tool and method to allow qualitative search and representation of results that may use lingual hierarchy, connotation and weight of authority for constructing a multidimensional conceptual model applicable to one or more documents. The linguistic construction tool and method may be used to augment the authoring process and the resulting documents. The linguistic construction tool may also be used to perform search related activities, for example, as a stand-alone search platform.

### BRIEF DESCRIPTION OF THE DRAWINGS

A more detailed understanding may be had from the following description, given by way of example in conjunction with the accompanying drawings wherein:

FIG. 1 is a diagram of an example authoring environment comprising a linguistic construction tool configured to use an underlying database of lingual relations necessary to support the functioning of a dynamically configurable research system;

FIG. 2 is a diagram of an example construction tool implemented on an application server;

FIG. 3 is a diagram of an example mapping of views to end user devices;

FIG. 4 is an overview diagram of an example method for performing linguistic construction;

FIG. 5 is a diagram of an example method for generating a lexical signature;

FIG. 6 is a diagram of an example method for generating linguistic hierarchy, connotations, and authority data;

FIG. 7 is a diagram of an example method for generating a subject/proximity map;

FIG. 8 is a diagram of a method for importing lexical signature data into a statement environment;

FIG. 9 is a diagram of an example method for authority generation/navigation;

FIG. 10 is a diagram of an example method for importing a document into a repository;

FIG. 11 is a diagram of an example view showing a document centric view of a document;

FIG. 12 is a diagram of an example view showing a statement centric view;

FIG. 13 is a diagram of an example view showing an individual cluster view;

FIG. 14 is a diagram of an example document/signature cluster view;

FIG. 15 is a diagram of another example document/signature cluster view;

FIG. 16A is a diagram of an example authoring mechanism;

FIG. 16B is a diagram of an example lexical signature; and

FIG. 16C is a diagram of an example connotative word axis.

### DETAILED DESCRIPTION

A system and method may be used to implement an authoring environment where sentence and thought construction may be facilitated through access to the internet materials that are filtered using a lingual hierarchy, connotation and weight of authority. A linguistic construction tool may be based on a hardware and/or software framework and use an underlying database of lingual relations necessary to support the functioning of a dynamically configurable research system. For example, the linguistic construction tool may be configured to enable a user to dynamically adjust various components of a sentence by sliding up or down a lingual hierarchy to achieve a desired meaning. The linguistic construction tool may be used to derive a lexical signature to enhance the thematic design and construction of an original work by drawing on established concepts, vocabulary and authorities in the subject area in which the author is writing.

The linguistic construction tool and method may enhance the writing process by shortening the inform-think-express cycle through an assisted writing mechanism on the author's computer system. The linguistic construction tool may be configured to analyze and recognize the domain of the writing, the context of the particular expression, and bridge the gap between the author's document and the material on the internet, minimizing impact on the authoring process. The following embodiments encompass a sentence and thought construction tool that may allow the author to focus on the subject area, understand the resources available on the internet, and continue working within the application where the work of expression is being conducted. The linguistic construction tool may additionally provide the ability to control the channel of information that is the internet such that the author may be provided with the most relevant material necessary for the work in which they are engaged. The author may leave this environment when they have to access information outside of the immediate scope of the document or the subject area being written about. Finally, with the assisted writing mechanism that the linguistic construction tool may provide, an author may benefit from the serendipitous exposure to related material as they are contemplating a new part of their work. This function may additionally provide the ability to fine-tune their expression when they are ready to commit words to the screen.

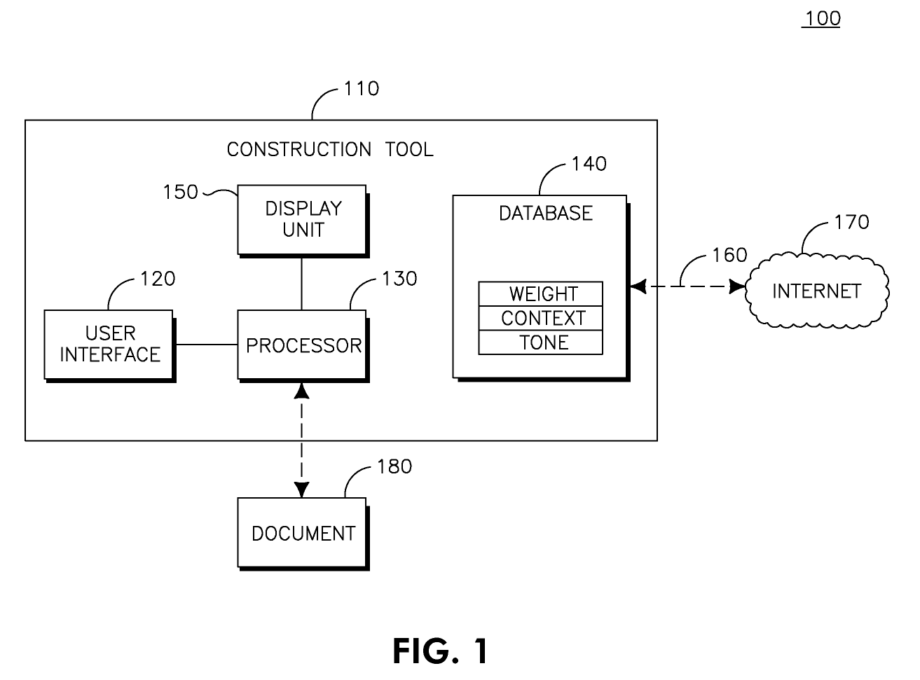

FIG. 1 is a diagram of an example authoring environment including a linguistic construction tool configured to use an underlying database of lingual relations necessary to support the functioning of a dynamically configurable research tool. The authoring environment 100 may include a linguistic construction tool 110 may comprise a user interface 120, a processor 130, a database 140, and an optional display unit 150. The database 140 may be internal or external and configured with an interface to connect to the internet 170. The processor 130 may be configured to extract linguistic information from the database, correlate the linguistic information with user input to determine a result, and embed the determined result into the user's project repository or an appropriate representation of the enriched document 180. The display unit 150 may visually display the determined result to enable dynamic adjustments to the user document 180. The display unit 150 may also be configured as a touch sensitive display and may also function as a user interface. The linguistic construction tool 110 may be configured to suggest synonymous words, concepts and metaphors for elaborating a sentence. The linguistic construction tool 110 may also be configured to allow a user to choose and explore themes and linguistic relationships to control the channel of information to acquire more meaningful results.

The linguistic construction tool 110 and method may use a configurable taxonomy of online language usage. For example, the language may include, but is not limited to English, Spanish, French, German, Chinese, Japanese, Russian, Hindi, etc.

In a first embodiment, the linguistic construction tool 110 may be configured to qualitatively differentiate lingual connotation and implement a method to distinguish weight of authority (WOA). The lingual connotation may be based on, for example, tonality, vocabulary, context, metaphorical context, source, author, etc. The WOA may be applied to existing documents to generate a multidimensional conceptual model of the content and quality of the document.

In a second embodiment, the linguistic construction tool 110 may be configured to generate a demonstrative representation of search results in a multidimensional display using the results of a search against the search target. For example, the search results may be displayed in a two-dimensional (2-D) format, a three-dimensional (3-D) format, a four-dimensional (4-D) format, and/or a multimedia format.

In a third embodiment, the linguistic construction tool 110 may be configured to incorporate this multidimensional approach to the authoring of new documents. For example, the multidimensional display unit 150 may be used to dynamically adjust linguistic parameters to enhance the authoring experience. For example, the multidimensional display unit 150 may be used to visually refine contextual meaning, computationally determine quality by virtue of the weight of supporting authority, and embed this compilation of derivative data within the document 180. The multidimensional display unit 150 may be configured to implement one or any combination of an adjustable sliding scale, a variety of adjustable toggle switches, a configurable graph/plot, or the like to enable adjustment of linguistic parameters.

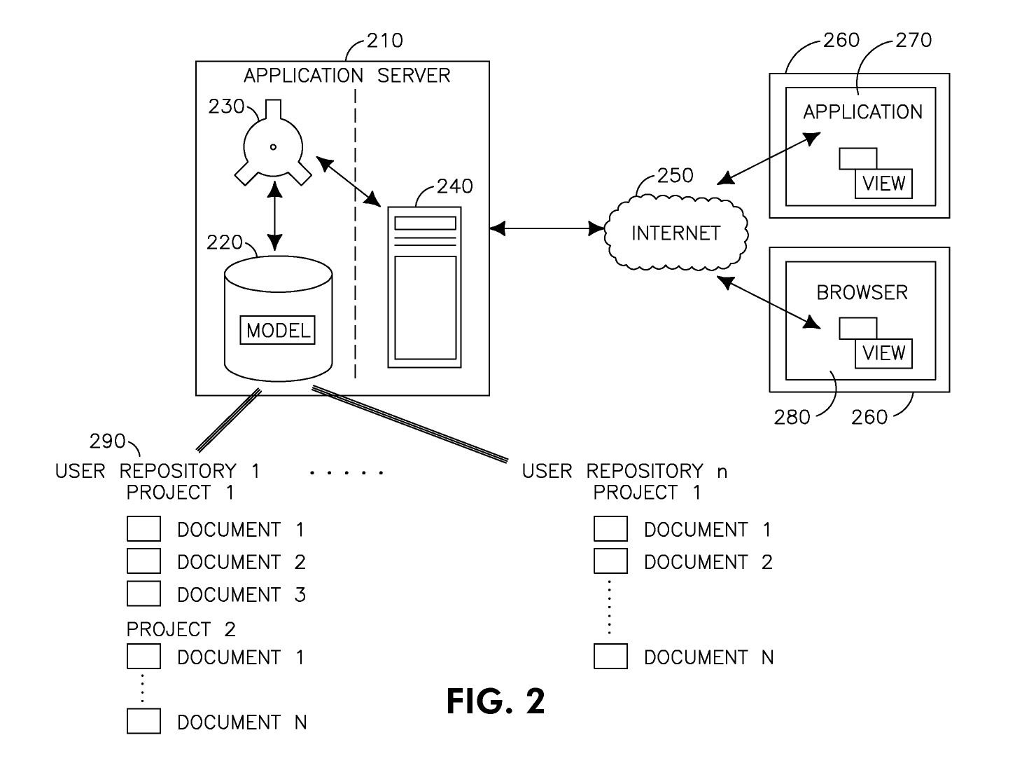

FIG. 2 is a diagram of an example construction tool implemented on an application server. As shown in FIG. 2, the application server 210 may include a model unit 220 and a controller unit 230. The model unit 220 and controller unit 230 may each be configured to communicate with a hardware unit 240. The application server 210 may be in communication with a network infrastructure 250, for example, the internet. The communication with the network infrastructure 250 may be a wired or wireless configuration. The application server 210 may communicate with an end user device 260, via the network infrastructure 250, using an application 270, a browser 280, or the like. The end user device 260 may be a wireless transmit/receive unit (WTRU), for example a cellular telephone, a smartphone, a personal digital assistant (PDA), a mobile personal computer (PC), a desktop PC, or any other suitable communication and/or computing device.

Referring to FIG. 2, the model unit 220 may be configured to perform as a user repository 290. The user repository 290 may be used to store data pertaining to at least one user. Each user may be allowed to configure their personal repository into separate projects containing project-specific documents. Each user repository 290 may be configured to enable security using a personal user identification (ID) and password.

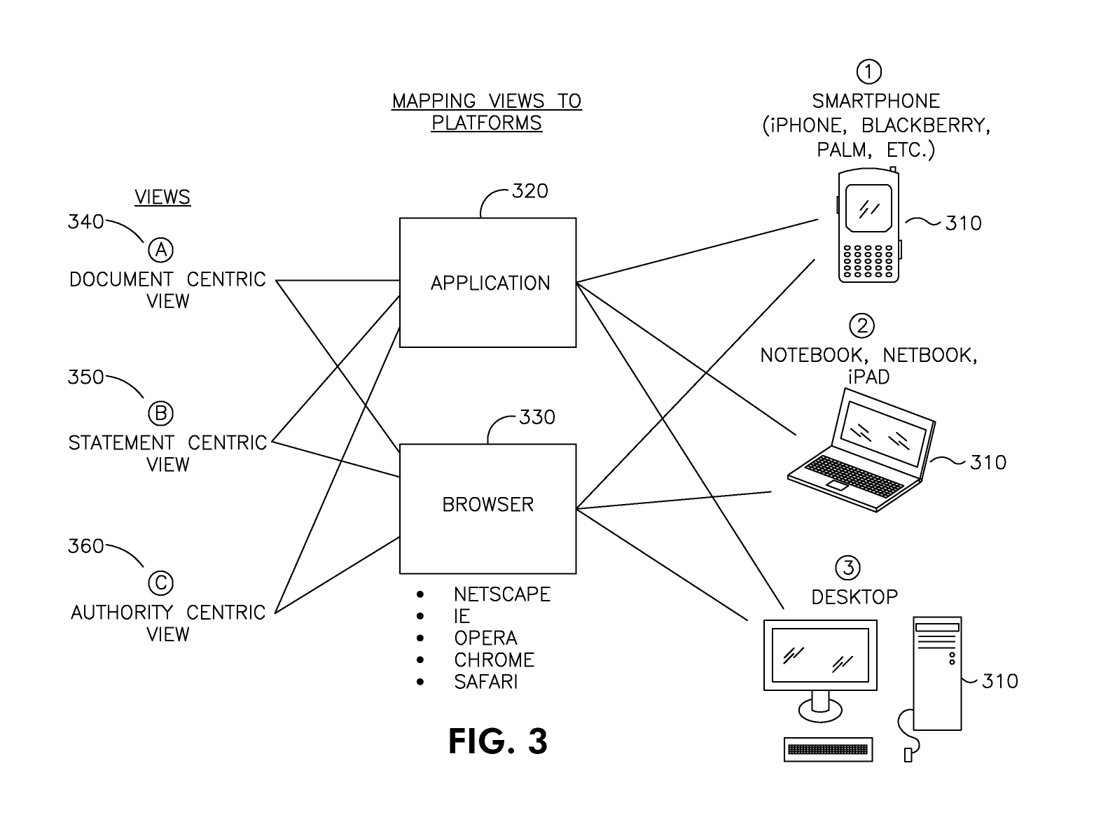

FIG. 3 is a diagram of an example mapping of views to end user devices. Referring to FIG. 3, an end user device 310 may use an application 320 or a browser 330 to produce a variety of views including, but not limited to, a document centric view 340, a statement centric view 350, and/or an authority centric view 360. Each view may be configurable based on a user preference. If a user preference is not defined, each view may be configurable based on at least one user's data stored in a centralized repository (not shown). The centralized repository may be configured as a portion of the model unit 220, or it may be configured as a separate internal or remote entity.

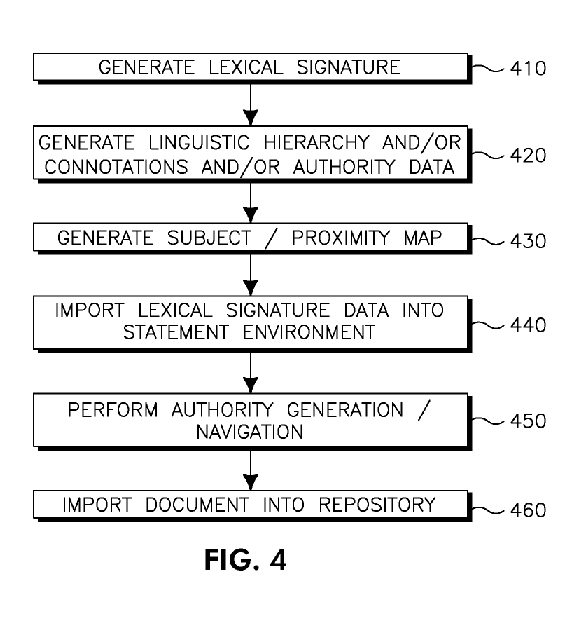

FIG. 4 is an overview diagram of an example method for performing linguistic construction. Referring to FIG. 4, the linguistic construction tool may generate a lexical signature 410. The lexical signature may be used to generate a linguistic hierarchy, connotations, and/or authority data 420. The linguistic hierarchy, connotations, and/or authority data may be used to generate a subject/proximity map 430. The generated lexical signature data may be imported into a statement environment 440. Once in the statement environment, the linguistic construction tool may be configured to perform authority generation/navigation. 450. Upon completion of the linguistic construction, or to save an unfinished product for future use, the document may be imported into a repository 460.

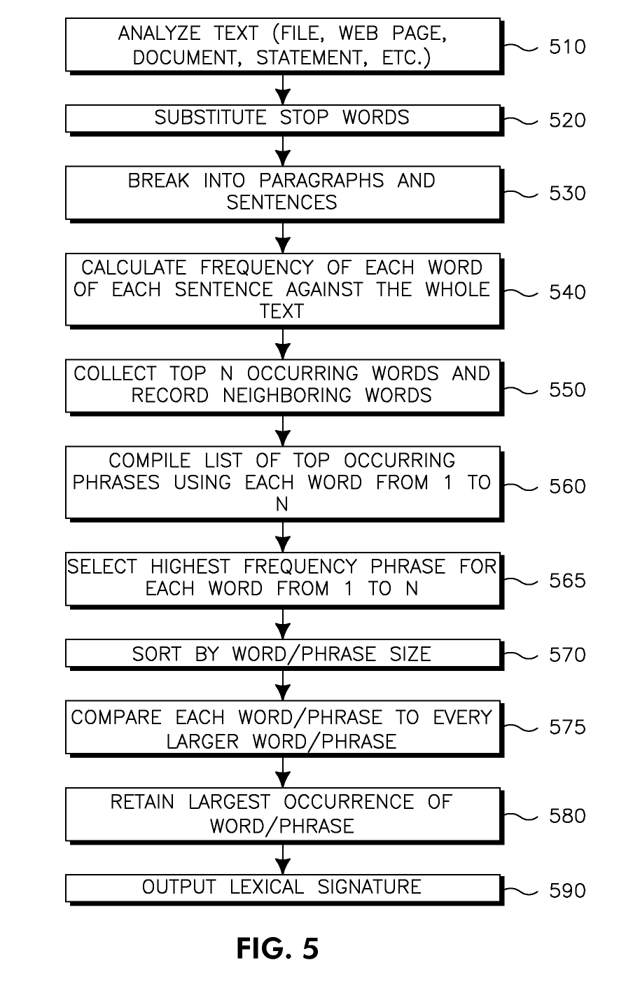

FIG. 5 is a diagram of an example method for generating a lexical signature. Referring to FIG. 5, the linguistic construction tool may analyze text 510. The text 510 may include, but is not limited to a text file, a powerpoint file, a spreadsheet document, a web page, a portable document format (PDF) document, a word processing document in any format, including XML representations of these types of files and any others which may be relevant to the project. The text 510 may also include a multimedia file, for example a photo with annotations, or a video with the relevant script/annotations associated with it, or the like. The analysis may include substituting or removing stop words 520. Stop words may be terms in a sentence or phrase that may not have any particular meaning. Stop words may vary by subject domain and may be removed to focus on the terms in the text that pertain more to the meaning of the text. The substitution or removal of stop words may be a natural language processing (NLP) step. Some examples of stop words may include, but are not limited to a, able, about, across, after, all, almost, also, am, among, an, and, any, are, as, at, be, because, been, but, by, can, cannot, could, dear, did, do, does, either, else, ever, every, for, from, get, got, had, has, have, he, her, hers, him, his, how, however, i, if, in, into, is, it, its, just, least, let, like, likely, may, me, might, most, must, my, neither, no, nor, not, of, off, often, on, only, or, other, our, own, rather, said, say, says, she, should, since, so, some, than, that, the, their, them, then, there, these, they, this, tis, to, too, twas, us, wants, was, we, were, what, when, where, which, while, who, whom, why, will, with, would, yet, you, and your.

The linguistic construction tool may then break the text into paragraphs and sentences 530 and calculate the frequency of each word or each sentence against the whole text 540. The top N occurring words may be collected and recorded with neighboring words 550. A list of top occurring phrases may be compiled using each word from 1 to N 560. The highest frequency phrase may be selected for each word from 1 to N 565. The list may be sorted by word or phrase size 570. Each word or phrase may then be compared to every larger word or phrase 575. The largest occurrence of the word or phrase may be retained 580 and output as the lexical signature 590.

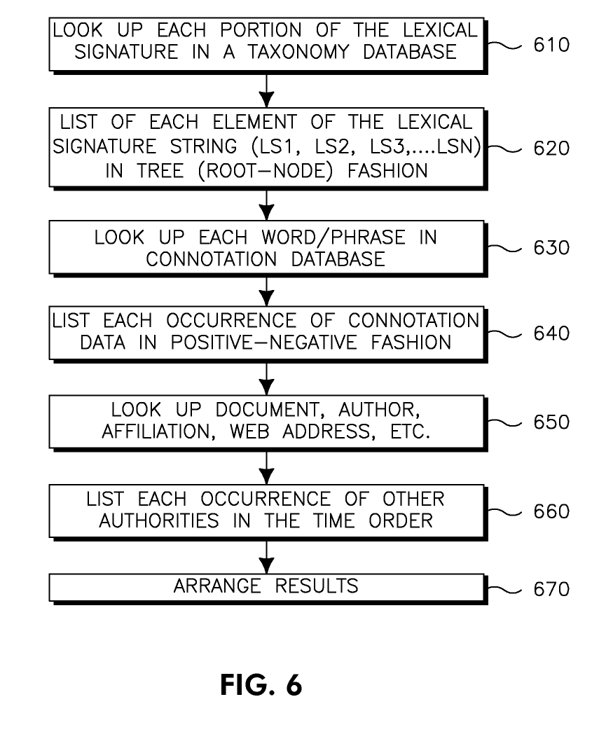

FIG. 6 is a diagram of an example method for generating linguistic hierarchy, connotations, and authority data. Referring to FIG. 6, to generate linguistic hierarchy, connotations, and authority data, the linguistic construction tool may look up each portion of the lexical signature in a taxonomy database 610. Some example taxonomy databases are listed in Table 1 below.

TABLE 1

| Name | URL |
|---|---|
| NAICS Industry Codes: | http://www.naics.com/search.htm |
| West's Analysis of | http://west.thomson.com/productdetail/ |
| American Law: | 154546/17304137/productdetail.aspx |
| Wikipedia: | http://en.wikipedia.org/ |
| Wordnet: | http://wordnetweb.princeton.edu/perl/webwn |
| Yahoo Industry Browser: | http://biz.yahoo.com/p/industries.html |

Referring again to FIG. 6, each element of the lexical signature string (LS1, LS2, LS3 . . . ) for that document may be listed in tree (root-node) fashion 620. Each word or phrase may then be searched in a connotation database 630 and listed in a positive-negative fashion 640. The connotation database may include, for example, relevant synonyms, antonyms, primary meanings, non-primary meanings, explicit meanings, implicit meanings, and/or any other information that may be derived from the context of the document, phrase, or term. The linguistic construction tool may then search a document, author, affiliation, web address, etc. 650 based on a received input. For example, a user may specify the author, affiliation and web address at the time the user enters the document to the system. This function may be automated to apply detection algorithms and data such that one or more author name and/or affiliation information may be analyzed before the text of the document is analyzed, and possibly supplemented with web data without any need for user input. Each occurrence of other authorities that may be found in connection with the author's institutional affiliation and/or web address may be listed in time order 660. These examples are illustrative and not exhaustive. Consider for instance, that authority data may be supplemented with social networking content from Facebook.com, Linkedin.com, Google's OpenSocial initiative and others in the social networking space. The results may then be arranged, for example on an x-axis for connotations, y-axis for linguistic hierarchy, and a z-axis for authorities 670.

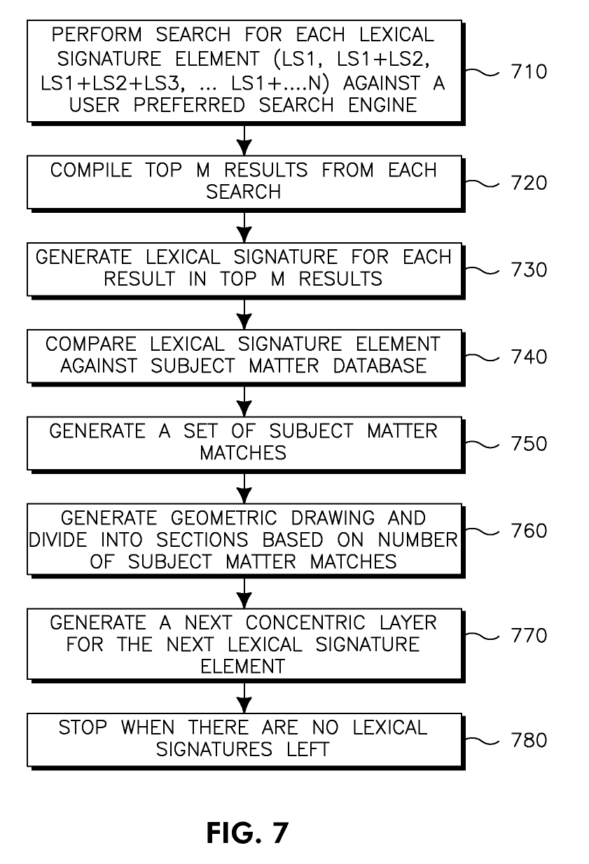

FIG. 7 is a diagram of an example method for generating a subject/proximity map. Referring to FIG. 7, the linguistic construction tool may perform a search for each lexical signature element (LS1, LS1+LS2, LS1+LS2+LS3, . . . LS1+ . . . LSN) using a search engine 710. The linguistic construction tool may be configured to use one or more preferred search engines. The linguistic construction tool may compile the top M results from each search 720 and generate a lexical signature for each result in the top M results 730. The lexical signature element may then be compared against a subject matter database 740.

The linguistic construction tool may then generate a set of subject matter matches 750 and generate a geometric drawing and divide the geometric drawing into sections based on the number of subject matter matches 760. The geometric drawing may be a circle, however, it is understood that the circle drawing is used merely as an example and that a drawing of any shape or form may be generated in its place. In this example, the linguistic construction tool may then generate a next concentric layer for the next lexical signature element 770. The generation of a next concentric layer may continue for each lexical signature element until all the lexical signature elements have been processed 780.

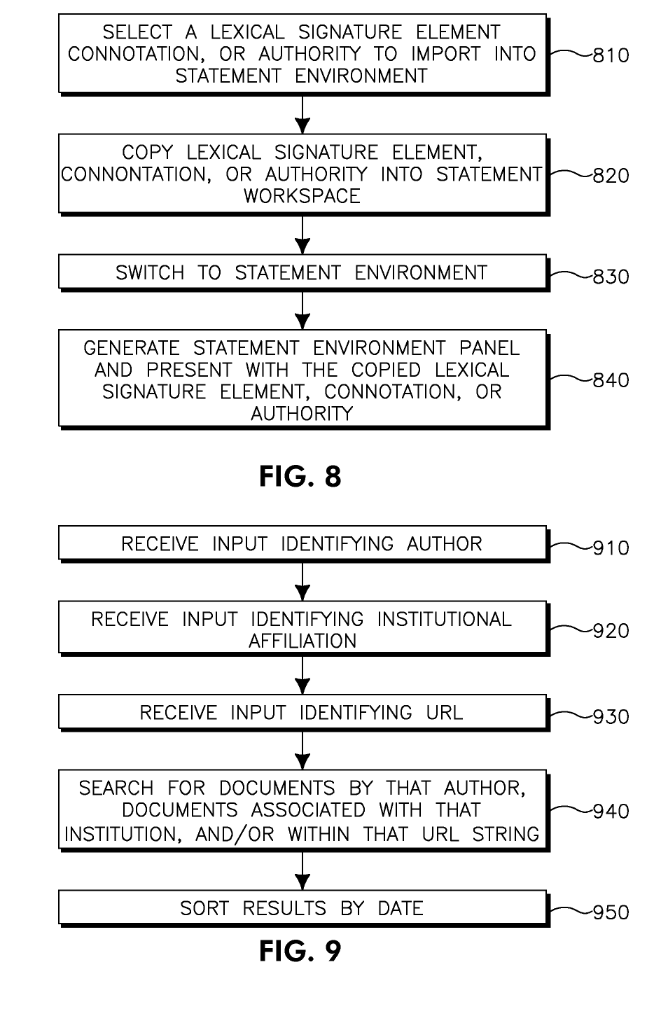

FIG. 8 is a diagram of a method for importing lexical signature data into a statement environment. Referring to FIG. 8, a lexical signature element, connotation, and/or authority may be selected to be imported into a statement environment 810. The lexical signature element, connotation, and/or authority data may be copied into a statement workspace 820. A user may then switch to view the imported text in a statement environment 830. The linguistic construction tool may then generate a statement environment panel on a display unit and present the panel with the copied lexical signature element, connotation, and/or authority data 840.

FIG. 9 is a diagram of an example method for authority generation/navigation. Referring to FIG. 9, the linguistic construction tool may receive an input identifying an author 910, and institutional affiliation 920, and/or a universal resource locator (URL) 930. Based on the input received, the linguistic construction tool may search for documents by that author, documents associated with that institution, and/or within that URL string 940 and compile this information as authority information. The search results may then be sorted by date 950 and presented on the display unit on a z-axis, for example. The authority information may also be automatically filled out using information in a document under inspection matched against semantic databases, such as, for example, Thomson's OpenCalais. Social connections between the author of the document under inspection and other authors may also supplement the search results. Material written by these related authors may similarly be matched against the lexical signature of the document under inspection and presented on the display unit on the z-axis.

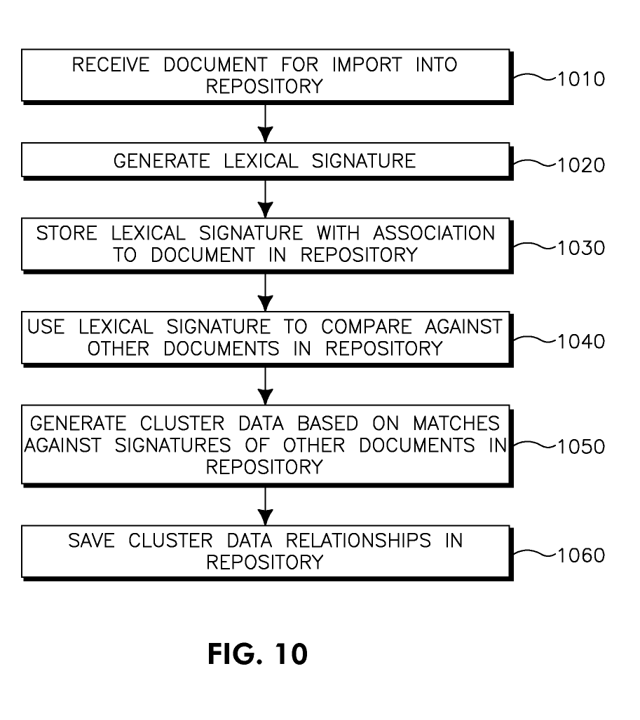

FIG. 10 is a diagram of an example method for importing a document into a repository. Referring to FIG. 10, the linguistic construction tool may receive a document for import into a repository 1010. The linguistic construction tool may then generate a lexical signature 1020 and store the lexical signature with an association to a document 1030. The lexical signature may be used to compare against other documents in a repository 1040. The linguistic construction tool may generate matches against signatures of other documents in the repository 1050. The lexical signature of the imported document may be compared to other documents in the repository. Where any elements in the lexical signature match documents already in the repository, these may be stored in the repository as cluster data 1060, for example, such that the relationship between the existing document, the lexical signature element that matches, and the document in the repository to which the lexical signature element matches may be retrieved and presented to the user at a later time.

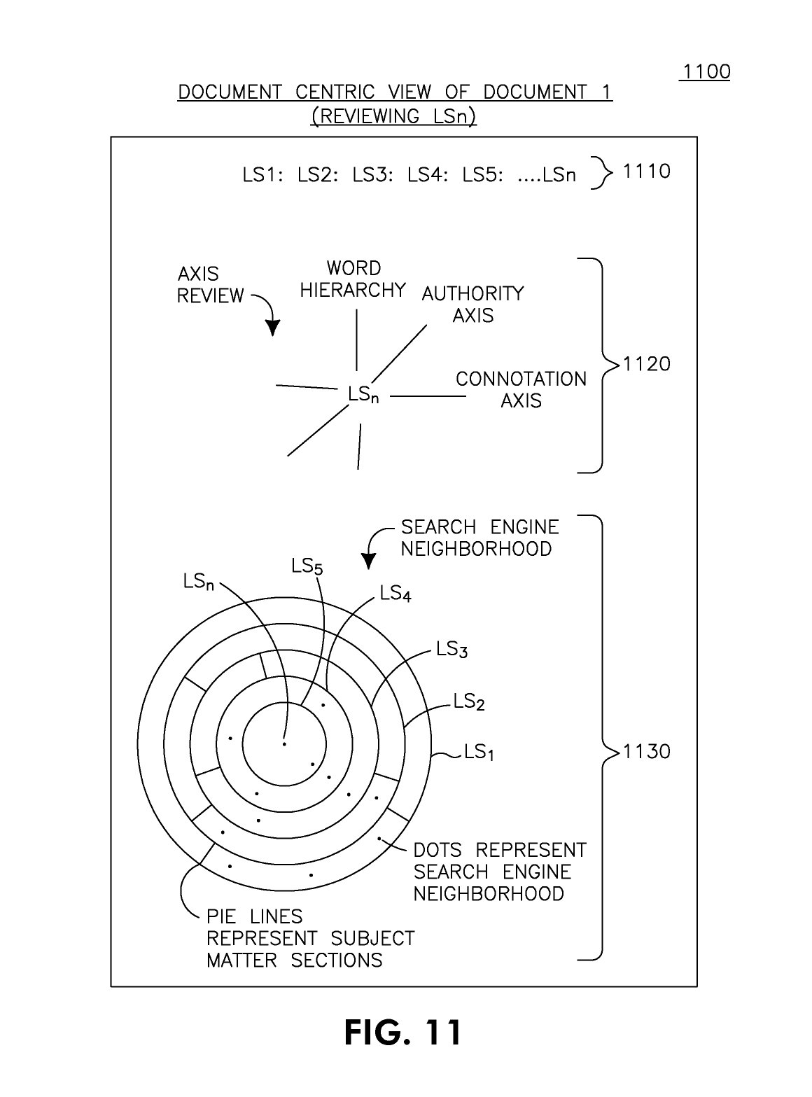

FIG. 11 is a diagram of an example view showing a view of Document 1. This document centric view 1100 includes a bread crumb trail component 1110, an axis review component 1120, and a search engine neighborhood component 1130. The bread crumb trail component 1110, axis review component 1120, and search engine neighborhood component 1130 may each be configurable and/or interactive. The search engine neighborhood component may be configured to produce subject matter sections based on data derived from the lexical signature of each result as shown in FIG. 7. These signature elements LS1 . . . LSN may be queried against the user's preferred search engine to produce N sets of results for (LS1, LS1+LS2, LS1+LS2+LS3 . . . LSN). For every subset of results in N, the system may calculate the lexical signature for the top M results. These secondary lexical signatures and their elements may be used to reference a subject matter database such as, for example, the Library of Congress Classification (LCCN) system. Each lexical signature element may be further searched against a catalog such as, for example, http://catalog.loc.gov/, to generate supplemental content. This supplemental content may provide additional subject matter classification information and may be used to match against the lexical signature of each result in the top M results. The subject matter matches with the highest frequency for each secondary lexical signature element may be used to calculate the subject matter sections to be represented in the search engine neighborhood component 1130.

Every subset of results may be represented by a concentric layer, for example, with every result represented as a dot in the concentric layer, and every subject matter section calculated in the above way may be drawn as section lines within that circle, with the corresponding dot appearing within the section lines for the subject matter identified for that result. Each dot in the concentric circle may represent a search result, where the search engine neighborhood may be the collection of the N sets of results. For example, an LS1 search may produce a set of results from the preferred search engine, an LS1+LS2 search may produce a set of results from the preferred search engine . . . an LS1+LS2+ . . . LSN search may produce a set of results from the preferred search engine, as shown in FIG. 11.

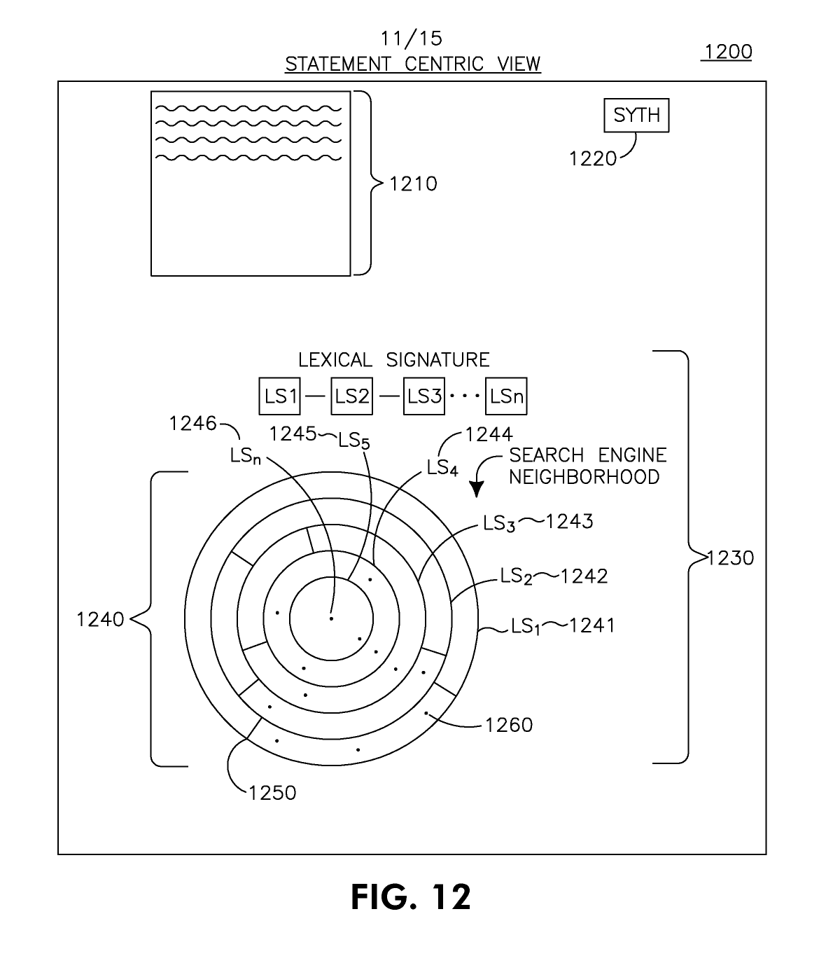

FIG. 12 is a diagram of an example view showing a statement centric view. Referring to FIG. 12, the statement centric view 1200 may include a statement component 1210, a function button 1220, and a lexical signature component 1230. The lexical signature component 1230 may include a graphical diagram 1240 organized by subject matter sections 1250. The graphical diagram 1240 may include several layers 1241-1246, each representing a lexical signature. The graphical diagram 1240 may also include search engine neighborhood information 1260.

In the statement centric view, a user may initiate processing of the document or text by clicking on the function button 1220. Clicking on the function button 1220 may initiate the calculation of the lexical signature, search engine neighborhood, and/or subject matter sections to generate the data to present in the lexical signature component 1230 of the statement centric view 1200.

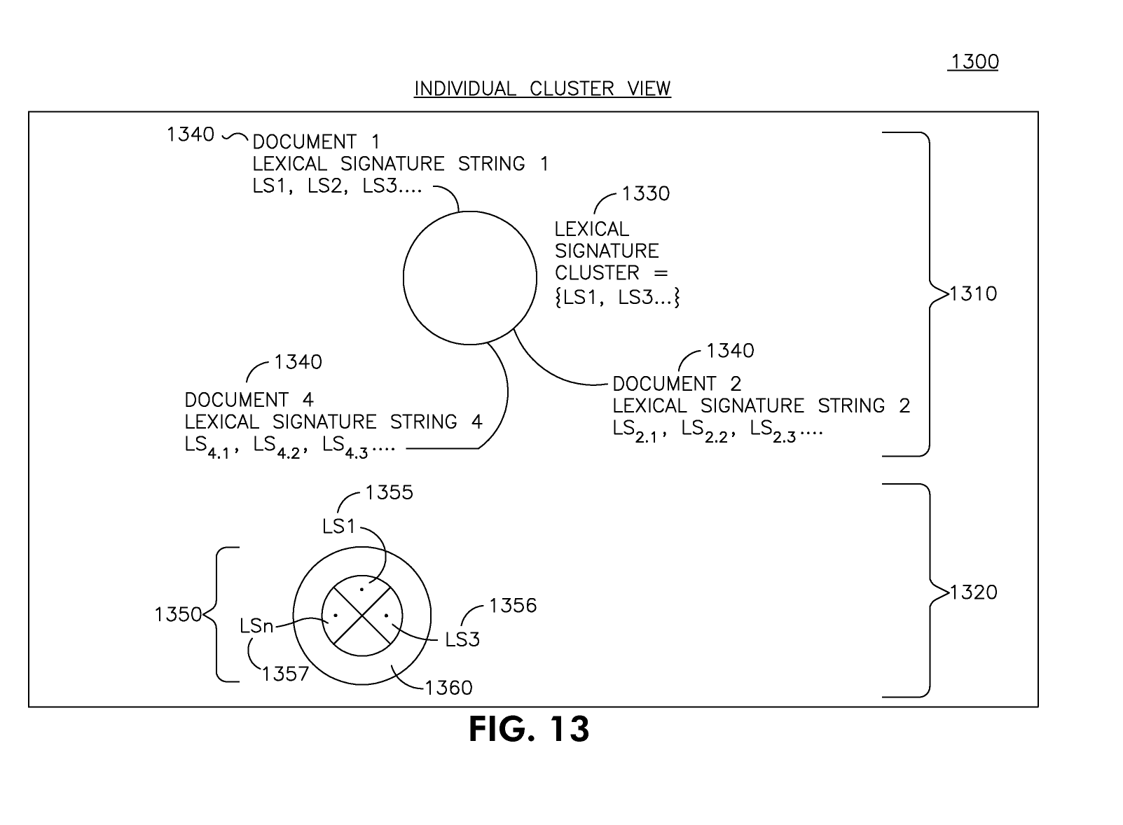

FIG. 13 is a diagram of an example view showing an individual cluster view. Referring to FIG. 13, the individual cluster view 1300 may include a document component 1310 and a cluster component 1320. The document component 1310 may include a lexical signature cluster component 1330 and a lexical signature string component 1340 for each of the displayed documents. The cluster component 1320 may include a graphical diagram 1350 that includes several sections 1355-1357 representing lexical signatures. Each lexical signature section may be grouped by subject area. The graphical diagram 1350 may include one or more layers 1360 representing overarching subject areas.

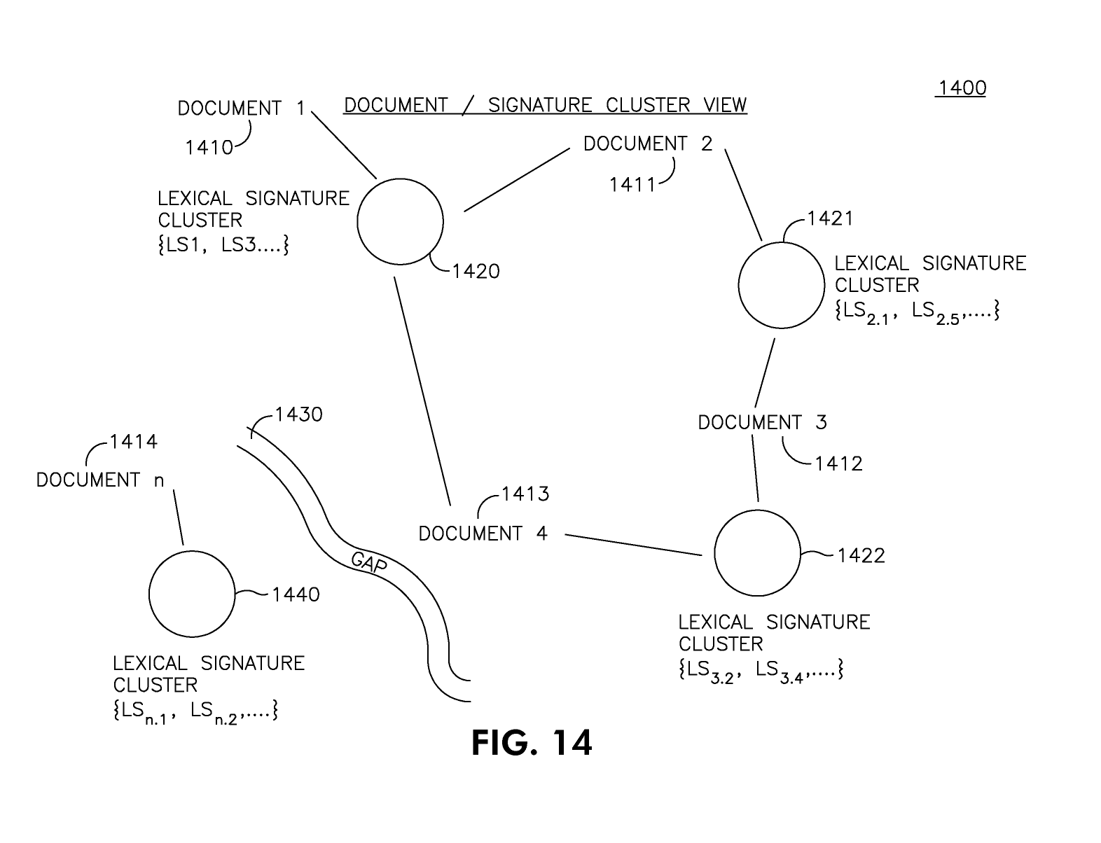

FIG. 14 is a diagram of an example document/signature cluster view. Referring to FIG. 14, the document/signature cluster view 1400 may include information from several documents 1410-1414 and signature cluster information 1420-1422 that may represent correlations of lexical signatures between documents. An indirect correlation may result if there is a gap 1430 in information. The document/signature cluster view 1400 may include signature cluster information 1440 that represents an indirect correlation to the other documents.

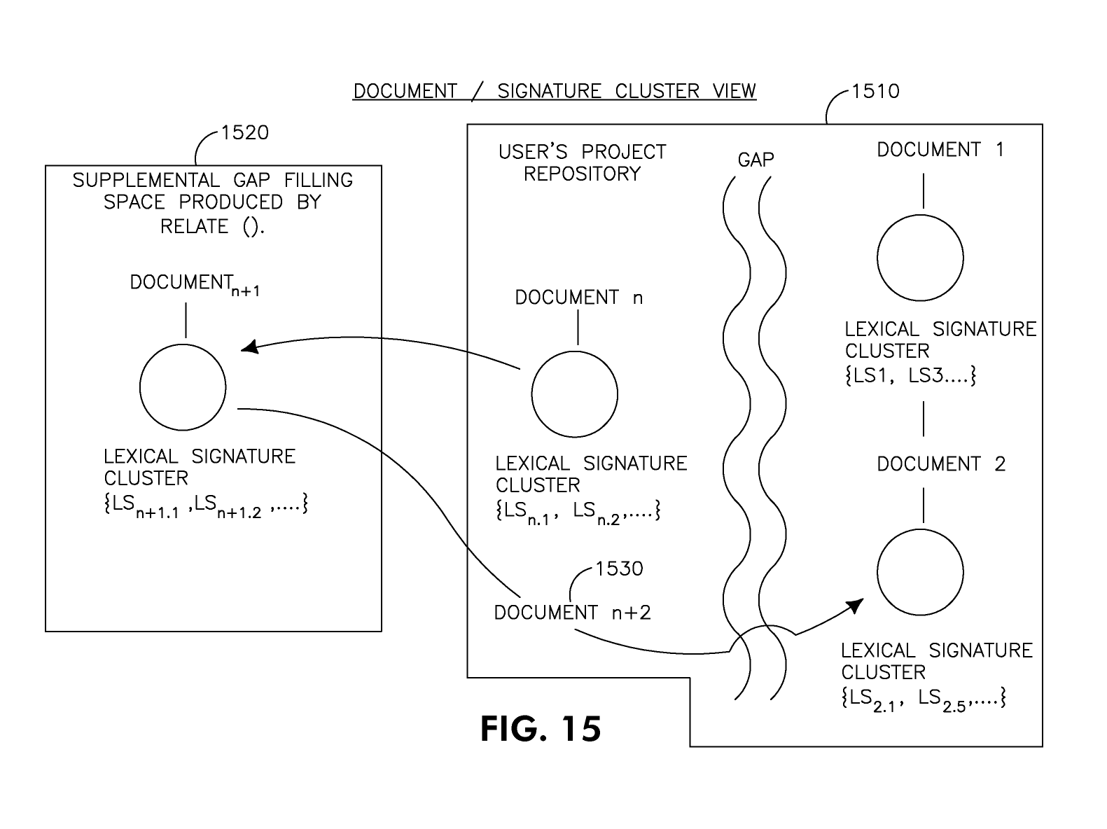

FIG. 15 is a diagram of another example document/signature cluster view. Referring to FIG. 15, when one or more documents in a user project repository 1510 does not share a lexical cluster relationship to other documents in the repository, there may be a gap filling function 1520. This gap filling function 1520 may propose potential connections 1530 that the user may accept or reject to supplement the repository for the project.

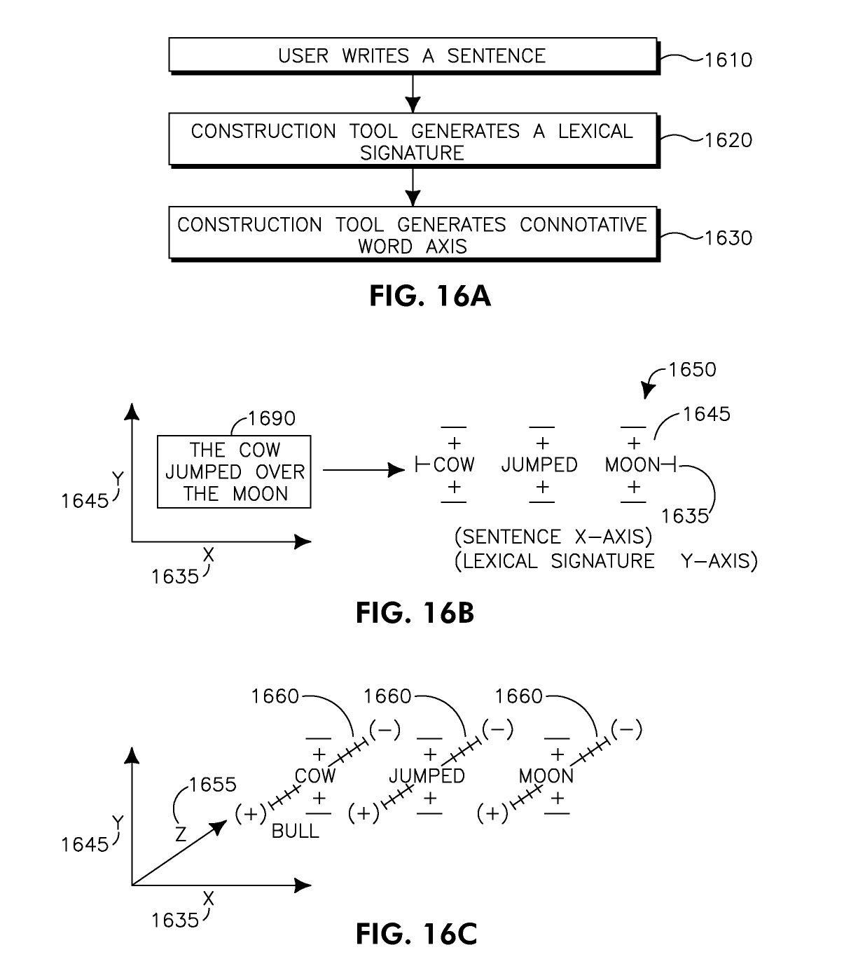

An example of an authoring mechanism is shown in FIG. 16A. When the user composes a sentence 1610, the linguistic construction tool may generate a lexical signature 1620 and a connotative word axis 1630. An example of a lexical signature for the phrase “the cow jumped over the moon” is shown in FIG. 16B. The x-axis 1635 may represent the sentence (or phrase) 1640 and the y-axis 1645 may represent the lexical signature 1650. The z-axis 1655 may represent the connotative word axis 1660 and is shown in FIG. 16C.

The linguistic construction tool may also generate meaningful references in relevant literature, using for example, an internet search, a periodical search, a book search, or a Library of Congress title search. The generated references may be used for enriching the connotative word axis to form a connotative concept, thought, citation, axis, etc.

The representation of the y-axis and/or z-axis may be shown visually. This may be an extension of the connotative concept, but beyond the typical word/concept internet search. The connotative search concept may be purely image driven, using one or any combination of the x-axis, y-axis, and z-axis. The connotative search may use images and correlate the images with an axis to provide a visual navigation and teaching tool.

In a fourth embodiment, the linguistic construction tool and method may build upon the foundation above to implement an indexing mechanism that allows a user to compile a grouping of documents that represents a search target. The linguistic construction tool may be used to execute searches to find relevant material by correlating the hierarchical nature of the configurable taxonomy, the lingual connotation, and the level of the WOA.

An example of the indexing mechanism may be illustrated for the phrase “the cow jumped over the moon.” This phrase may be structured in a variety of ways, for example, “jumped over the moon the cow did,” “cow is jumping up the moon,” or “over the moon, the cow jumped.” These examples are stylistically different, but may be used to develop enriched results.

Performing a search using an indexing-assist mechanism may provide a more robust and refined search result over the typical commoditized term-based searching available on the Internet. The method may perform a series of passes to refine the search. The first pass of an indexing-assist processor (back end) may remove stop words. A second pass may apply a lexical signature to all words. A formula that relates the degree of literal matching to the degree of analogous matching may be used to express the degree of conceptual relation between pass 1 and pass 4.

The indexing-assist processor may calculate literal and conceptual matches. These matches may be weighted appropriately and removed to generate a conceptual relation quotient. The conceptual relation quotient may be a number, a named pair (i.e., URL for pass 1, degree of relation to pass 1 found in database record for pass 2), an index looking in a proprietary database for the actual relation, or some other scalable mechanism.

In the named pair example, a document may have multiple named pairs to express its relation to other documents as they are compiled over time. The outer bound on this document's named pairs may be limited by early cycle algorithmic comparisons using the abstraction ladder. Therefore, only the document pairs for actual grammatical and stylistic variations may be compiled. If there is a succinct amount of data that arises, and of these calculations which may be embedded as metadata within the document itself, then the user may have the option of citing the document into a document set or repository and having these relations calculated. This indexing-assist mechanism may be used to aid in authoring and search.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A linguistic construction tool comprising:
a user interface;
a processor operatively coupled to the user interface,
a database operatively coupled to the processor; and
a display unit operatively coupled to the processor,
wherein the processor is configured to extract linguistic information from the data base.

2. The linguistic construction tool of claim 1, wherein the database is configured with an interface to connect to the internet.

3. The linguistic construction tool of claim 1, wherein the processor is configured to correlate the linguistic information with user input to determine a result.

4. The linguistic construction tool of claim 3, wherein the processor is further configured to embed the determined result into a user document.

5. The linguistic construction tool of claim 1, wherein the display unit is configured to display the determined result to enable dynamic adjustments to the user document.

6. The linguistic construction tool of claim 1, wherein the processor is configured to suggest synonymous words for elaborating a sentence.

7. The linguistic construction tool of claim 1, wherein the processor is configured to suggest a concept for elaborating a sentence.

8. The linguistic construction tool of claim 1, wherein the processor is configured to suggest a metaphor for elaborating a sentence.

9. The linguistic construction tool of claim 1, wherein the processor is configured to allow a user to choose and explore themes and linguistic relationships to control the channel of information to acquire more meaningful results.

10. The linguistic construction tool of claim 1, wherein the processor is further configured to qualitatively differentiate lingual connotation and implement a method to distinguish weight of authority (WOA).

11. The linguistic construction tool of claim 10, wherein the WOA may be applied to existing documents to generate a multidimensional conceptual model of the content and quality of the document.

12. The linguistic construction tool of claim 10, wherein the lingual connotation is based on at least one from the group of tonality, vocabulary, context, metaphorical context, source, or author.

13. The linguistic construction tool of claim 1, wherein the processor is configured to implement an indexing mechanism that allows a user to compile a grouping of documents that represents a search target.

14. The linguistic construction tool of claim 1, wherein the processor is configured to execute searches to find relevant material by correlating a hierarchical configurable taxonomy, a lingual connotation, and the level of the WOA.

15. The linguistic construction tool of claim 1, wherein the processor is configured to generate a demonstrative representation of search results in a multidimensional display using the results of a search against the search target.

16. The linguistic construction tool of claim 15, wherein the multidimensional display is in a two-dimensional (2-D) format, a three-dimensional (3-D) format, a four-dimensional (4-D) format, or a multimedia format.

17. The linguistic construction tool of claim 1, wherein the processor is configured to incorporate a multidimensional approach to authoring new documents.

18. The linguistic construction tool of claim 17, wherein the multidimensional display is used to dynamically adjust linguistic parameters to enhance the authoring experience.

19. The linguistic construction tool of claim 17, wherein the multidimensional display is used to visually refine contextual meaning, computationally determine quality based on a weight of supporting authority, and embed the compilation of derivative data within the document.

20. The linguistic construction tool of claim 15, wherein the multidimensional display is configured to implement one or any combination of an adjustable sliding scale, a variety of adjustable toggle switches, a configurable graph/plot to enable adjustment of linguistic parameters.
